(19) United States
(12) Patent Application Publication
(10) Pub. No.: US 2003/0136878 A1
(43) Pub. Date: Jul. 24, 2003

(54) Method and apparatus for impeding unauthorized entry into the cockpit of an airplane

(76) Inventor: Ronald R. Watson, Scottsdale, AZ (US)

Correspondence Address: TOD R. NISSLE, P.C., P.O. Box 55630, Phoenix, AZ, 85078, US

(21) Appl. No.: 10/273,426

(22) Filed: Oct. 17, 2002

Related U.S. Application Data
(60) Provisional application No. 60/330,148, filed on Oct. 17, 2001.

(51) Int. Cl. B64D 11/00; B64D 13/00

(52) U.S. Cl. 244/118.5

(57) ABSTRACT

A method and apparatus for impeding unauthorized entry into an aircraft cockpit installs a pliable cut resistant netting over the doorway to the cockpit. The netting is secured in place from inside the cockpit.

This invention relates to airplanes.

More particularly, the invention relates to a method and apparatus for impeding the unauthorized entry into the cockpit of an airplane.

Unfortunately, in the course of commercial aviation and military aviation, instances occur where individuals intend to gain unauthorized entry into the cockpit of an airplane to disable the flight crew, to take over the plane, to destroy the plane, etc. It would be desirable to provide a method and apparatus which would effectively impede entry into the cockpit and give a flight crew time to react, notify the appropriate authorities, and take other desired actions. It would also be desirable to provide a method and apparatus which permits a pilot to utilize the restroom on an airplane and impedes the ability of an unauthorized individual to gain access to the cockpit when a member of the flight crew leaves the cockpit to use the restroom.

Therefore, it is a principal object of the invention to provide an improved method and apparatus for impeding entry into the cockpit of an airplane.

This, and other, further and more specific objects of the invention will be apparent to those skilled in the art from the following detailed description thereof, taken in conjunction with the drawings, in which:

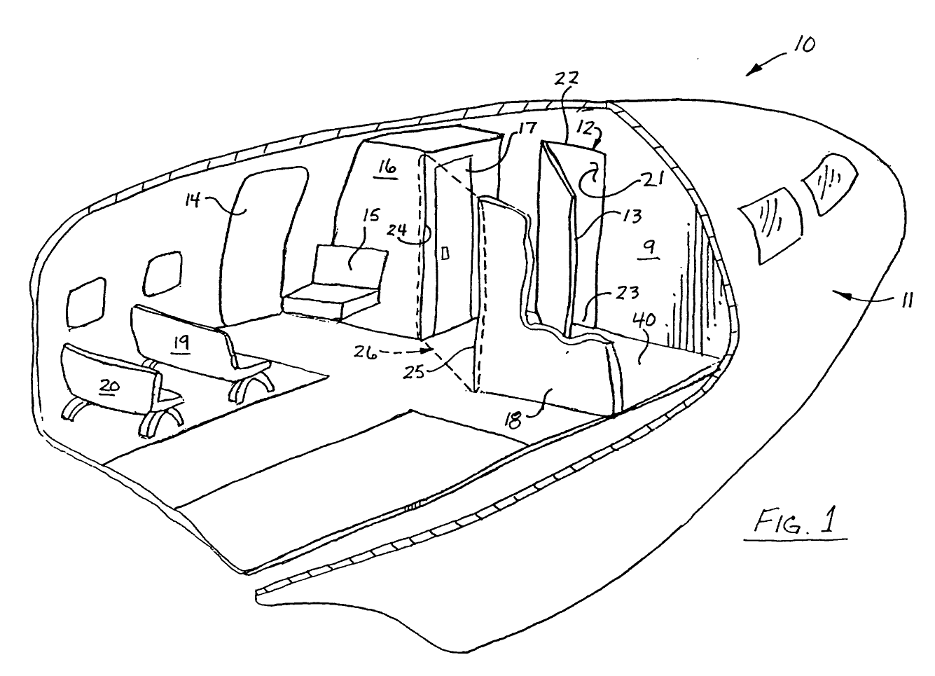

FIG. 1 is a top section view illustrating the forward portion of an aircraft; and,

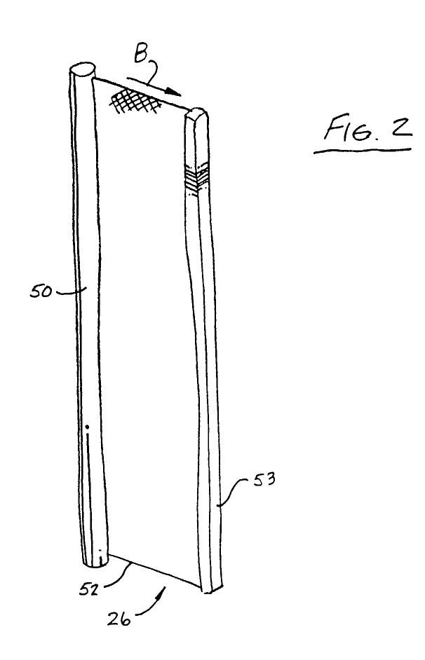

FIG. 2 is a perspective view illustrating a closure utilized to create in an aircraft a safe zone that is separated from the passenger compartment and that permits a crew member to leave the airplane cockpit and enter a restroom.

Briefly, in accordance with the invention, I provide improvements in an airplane. The airplane includes a passenger compartment; a crew compartment; a wall between the passenger compartment and crew compartment; a doorway in the wall leading from the passenger compartment to the crew compartment; a door mounted at the doorway, the door movable between a closed position blocking the doorway and an open position; a restroom positioned outside the crew compartment and intermediate the passenger compartment and crew compartment; and, a restroom door for accessing the restroom. The improvements impede unauthorized entry into the crew compartment from the passenger compartment and creating a safe zone between the passenger compartment and crew compartment which includes the restroom door. The improvements include a closure moveable between at least two operative positions, an open position and a closed position. In the closed position, the closure prevents passengers from accessing the restroom door and the crew cockpit.

Turning now to the drawings, in which the presently preferred embodiments of the invention are illustrated not by way of limitation of the invention and in which like characters refer to corresponding elements throughout the several views, FIG. 1 illustrates the front portion 11 of an airplane 10. Portion 11 includes door 14 through which passengers and crew enter and leave plane 10 when plane 10 is stationary on the ground, and includes vertically oriented wall 9 separating the passenger compartment from the cockpit area 21. The pilots and navigator, and possibly other flight crew members, sit in the cockpit area 21 when they are operating plane 10. Door 13 is mounted in doorway 12 and can be opened and closed in conventional fashion. Door 13 also preferably includes a lock that permits a member of the flight crew to lock door 13 while standing in the cockpit. When door 13 is closed and locked, ready entry into the cockpit area 21 is prevented.

Door 17 permits entry into and out of restroom 16. Restroom 16 is located outside cockpit area 21 and is spaced apart from area 21. Seat 15 typically is utilized by a flight attendant. In FIG. 1, restroom 16 is forward, or to the right of, door 14. Restroom 16 can be rearward, or to the left of, door 14 in FIG. 1. Restroom 16 includes vertically oriented edge 24.

Wall 18 includes vertically oriented edge 25. Wall 18 separates the passenger compartment from a galley (not shown) which ordinarily is positioned intermediate wall 18 and wall 9. Flight attendants use the galley to prepare food and drink for passengers. A plurality of seats 19, 29 are provided in the passenger compartment for passengers.

Door or closure apparatus 26 is used to produce a safe area including the restroom 16 (or entry 17 to the restroom) and the door 13 to the cockpit area 21. The safe area can also include the galley and, possibly, door 14. It is possible for the closure apparatus 26 to be installed such that the safe area includes one or more seats used by passengers in the passenger compartment of the airplane 10, but this normally is not desirable. The principle function of closure apparatus 26 is to form a safe area that enables the flight crew to move between restroom 16 and the cockpit area 21 while at the same time blocking or sealing off the passenger compartment so that most or all of the individuals in the passenger compartment do not have access to the safe area.

When, in FIG. 1, the closure apparatus is deployed, the safe area produced includes restroom 16 (including door 17), and includes the area or space bounded by closure apparatus 26, walls 18 and 9, door 13, floor 40, and the portion of the ceiling or wall of airplane 10 that is above floor 40. Doors 17 and 13 can be accessed from the safe area.

In one embodiment of the invention, closure apparatus 26 comprises the apparatus illustrated in FIG. 2. The apparatus 26 of FIG. 2 includes vertically oriented hollow tube 50. Pliable rectangular sheet 52 is mounted on a spring loaded roller. The roller is vertically oriented and mounted inside tube 50 such that edge 53 can be grasped and sheet 52 pulled outwardly from tube 50 in the direction of arrow B. If edge 53 is released, the spring loaded roller pulls sheet 52 in a direction opposite that of arrow B back inside tube 50. In use, tube 50 is mounted in a vertical orientation along edge 24. When sheet 52 is deployed, it extends from edge 24 to vertically oriented edge 25 in the manner indicated by dashed lines 26 in FIG. 1. Edge 53 is attached to a vertically oriented structural member (not shown) that is affixed to vertically oriented edge 25. A locking mechanism can be provided to secure edge 53 in position adjacent edge 25 so that a person in the passenger compartment can not readily unlatch or open the closure apparatus by allowing sheet 52 to travel back into tube 50. The locking mechanism preferably can only be operated by a flight attendant standing in the safe area, and not by a person standing in the passenger compartment.

The position in aircraft 10 at which closure apparatus 26 is installed can vary as desired, and the shape and dimension of the closure apparatus can vary as desired. The principal function of the closure apparatus is, however, to provide an impediment to a passenger's moving from the passenger compartment into the safe area created when the closure apparatus is closed. Doors 17 and 13 can be accessed from the safe area, and, the galley and possibly door 14 typically may also be accessible from the safe area.

Closure apparatus 26 can be constructed in any desired manner and can comprise a conventional door, can comprise the roll-out structure depicted in FIG. 2, can comprise a structure that rolls up and down like a window shade, can comprise a roll down structure comprises a series of parallel articulated slats, etc. Closure apparatus 26 can completely block access to the safe area. However, if desired, closure apparatus 26 need not, when closed, completely block access to the safe area created by the closure. For example, a space may exist between the top of the closure and the ceiling of the aircraft. The objective is to make any such space small enough that it is not practical for a person to attempt to crawl through the space to gain entry to the safe area when closure apparatus 26 is closed.

When the closure apparatus 26 illustrated in FIG. 2 is used, sheet 52 can be fabricated from any desired material but preferably is made with a puncture resistant polymer attached to a mesh fabricated from Kevlar.

Closure apparatus normally includes means operable from within the safe area to lock the closure apparatus in fixed position when the closure apparatus is deployed to create the safe area and prevent individuals in the passenger compartment from accessing the safe area.

Having described my invention in such terms as to enable those of skill in the art to understand and practice it and having described the presently preferred embodiments and best mode thereof, I claim:

1. In combination with an airplane including
a passenger compartment,
a crew compartment,
a wall between the passenger compartment and crew compartment,
a doorway in the wall leading from the passenger compartment to the crew compartment,
a door mounted at the doorway, the door movable between a closed position sealing the doorway and an open position,
a restroom positioned outside the crew compartment and intermediate the passenger compartment and crew compartment, and
a restroom door for accessing the restroom,
the improvements for impeding unauthorized entry into the crew compartment from the passenger compartment and for creating a safe zone between the passenger compartment and crew compartment which includes the restroom door, the improvements including a closure moveable between at least two operative positions, an open position and a closed position, said closure in said closed position preventing passengers from accessing the restroom door and the crew cockpit.
